(19) United States
(12) Patent Application Publication
(10) Pub. No.: US 2005/0078226 A1
(43) Pub. Date: Apr. 14, 2005

(54) Remote control device, and setting system and setting method thereof

(75) Inventor: Hiroshi Matoba, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 10/952,182

(22) Filed: Sep. 29, 2004

(30) Foreign Application Priority Data
Sep. 30, 2003 (JP) 2003-340068

(51) Int. Cl. G08C 19/00; H04N 5/44

(52) U.S. Cl. 348/734; 340/825.73

(57) ABSTRACT

A device main body capable of screen display by television output, and a remote control device which has a specific button that enables setting of a plurality of kinds of code outputs to remotely operate the device main body are provided, in which the remote control device, when any one kind of the plurality of kinds of code outputs is selected, temporarily sets the specific button by the selected kind of code output, as well as transmitting, to the device main body, the kind of the temporarily set code output and causing the kind to be displayed on the screen, and when input to the effect that main setting is to be conducted is made, transmits, to the device, a kind of a code output temporarily set at the specific button at present to cause the kind to be again displayed on the screen.

### BACKGROUND OF THE INVENTION

1. Field of the Invention

The present invention relates to a system and a method for presetting a remote control device which remotely operates a device having an output to a television (hereinafter simply referred to as a TV). Here, the device having an TV output includes, other than recorders such as an HDD (Hard Disk Drive) recorder, a DVD (Digital Versatile Disk) recorder and a VCR (Video Cassette Recorder), various kinds of devices connected to a TV such as a DVD player and a BS tuner.

2. Description of the Related Art

In general, remote control devices attached to such devices as VCR (including a VTR (Video Tape Recorder) and a videocassette recorder) are designed to operate channels, volume and the like of a TV as an externally connected apparatus as well. Because TV uses a manufacturer- or machine-dependent remote control signal, users, when operating the TV by a remote control device, need to change setting of the remote control device according to the manufacturer of the TV used, that is, to conduct so-called presetting. In the presetting of the remote control device, a code (manufacturer code) of the manufacturer of the TV used is set by the operation of a button which is not used in ordinary button operation, more specifically, by the operation of pressing a channel number button (e.g. button “0”-“12”) while pressing a specific button such as a power button. In general, because users can bring up no image of a corresponding relationship between a button and a code, it is a common practice to conduct presetting while referring to a cross-reference table of manufacturer codes (list of manufacturers and codes) attached to a user's manual.

In presetting conducted by using a manual as described above, however, every time setting contents of a remote control device return to an initial value due to a dead battery or the like, users need to search for the manual and preset the remote control device, which is laborious. Another problem is that losing a manual makes presetting itself impossible.

Under these circumstances, presented are systems enabling presetting of remote control devices without manuals. For example, recited in Japanese Patent Laying-Open (Kokai) No. 2000-123559 (Literature 1) is the system in which when receiving a remote control signal from a remote control device, a VTR determines whether the received remote control signal is a signal from its own remote control device for VTR and when the signal is not so, refers to a table (which enables a manufacturer of a device controlled by the remote control device to be specified from a remote control signal) prepared in advance based on the received remote control signal to specify a manufacturer of the remote control device and display an operation procedure of presetting for adapting its own VTR remote control device to the specified manufacturer. Users preset the VTR remote control device according to the displayed procedure.

Other method than that described above is such a remote control device presetting method as recited in Japanese Patent Laying-Open (Kokai) No. Heisei 4-267696 (Literature 2). In the present presetting method, at the time of presetting, a preset remote control device is connected to a main body of a VTR by a wire to make the VTR main body side display items necessary for presetting, while a user sets information necessary for the displayed items by selection input. Names of manufacturers are sequentially displayed on a display unit by operating an item selection key provided in the main body of the VTR, so that a user is allowed to select a desired manufacturer according to the display. After entering information into necessary items, when pressing an execution key provided in the main body of the VTR, the contents of each item will be transferred from the VTR main body to the preset remote control device to complete presetting.

As described in the foregoing, in presetting conducted by using a manual, every time a battery runs out, it is necessary to search for the manual and preset a remote control device and when the manual is lost, presetting itself will be impossible, which causes great inconvenience. In addition, when designating a manufacturer code by the combination of a channel number button and a specific button, no user is allowed to check to which manufacturer the designated code belongs, so that he/she might conduct presetting by an erroneous code.

The system recited in Literature 1 causes a problem that for presetting a VTR remote control device, a remote control device of a TV used is required and when the remote control device of the TV develops a failure, no presetting of the VTR remote control device is possible.

With the system recited in Literature 2, it is necessary to connect a preset remote control device to a main body of a VTR by a wire at the time of presetting, which is laborious.

### SUMMARY OF THE INVENTION

The object of the present invention is to provide a system and a method which solve the above-described problems to enable manufacturer codes to be set at a remote control device with ease and with reliability.

According to the first aspect of the invention, a remote control device setting system comprises a device capable of screen display by television output, and a remote control device having a specific button which enables setting of a plurality of kinds of code outputs to remotely operate the device, wherein the remote control device, when input is made for selecting any one code output of the plurality of kinds of code outputs, temporarily sets the specific button by the selected code output, as well as transmitting, to the device, a signal which causes a kind of a temporarily set code output to be displayed on the screen, and when input for main setting is made, transmits, to the device, a signal which causes the kind of the code output temporarily set at the specific button to be displayed on the screen.

In the above-described structure according to the present invention, when a user selects any one kind of a plurality of kinds of code outputs (more specifically, manufacturer name) on a remote control device, a specific button is temporarily set by the selected kind of code output, while the screen (more specifically, TV screen) of the kind of the temporarily set code output is displayed. This enables the user to check a kind of code output on the screen to set a target code output (target manufacturer code output) without using a manual or other remote control device (TV remote control device). In addition, since display of a kind of code output onto a screen is conducted by remote operation (more specifically, infrared communication), it is not necessary to connect a remote control device and a device by a wire.

In the above-described displaying of a kind of temporarily set code output onto a screen, the device can not receive a signal from the remote control device satisfactorily depending on a positional relationship between the remote control device and the device or a direction of the remote control device to the device, so that a kind of code output which is different from the kind of code output temporarily set at present at the remote control device might be displayed on the screen, which will be described in detail in the following embodiment. In such a case, if main setting is conducted determining that the kind of code output displayed on the screen is the kind of code output temporarily set at the remote control device at present, a code output different from the code output which the user thinks it has been set at the remote control device will be set. With the above-described structure according to the present invention, when input is made to the effect that main setting will be conducted on the remote control device, the kind of code output temporarily set at present is again displayed on the screen, so that the user is allowed to confirm, on the screen, the kind of code output temporarily set at present. Therefore, as long as operation is conducted according to a displayed screen, the user can set a target code output at the remote control device.

In the preferred construction, the remote control device further including an operation button by which relative input operation is conducted, wherein based on an output according to the relative input operation of the operation button, a code output for temporarily setting the specific button is sequentially determined from among the plurality of kinds of codes outputs.

This structure enables a user to select, on the screen, a kind of code output which he/she wants to set at a remote control device with ease by conducting input operation using buttons which enable relative input operation such as “+/−” buttons or a cross key.

In another preferred construction, the remote control device further including an operation button by which relative input operation is conducted, wherein based on an output according to the relative input operation of the operation button, a code output for temporarily setting the specific button is sequentially determined from among the plurality of kinds of codes outputs, and further including:
an operation/setting conversion table where a plurality of identifiers which respectively specify the plurality of kinds of codes are sequentially stored starting at an address as a reference, an output of the operation button being a relative amount of movement from the address as a reference, an operation/setting information conversion unit which obtains an identifier of an address corresponding to an output of the operation button from the operation/setting conversion table, an internal setting updating unit which temporarily sets the specific button by a code output of a kind corresponding to the identifier obtained by the operation/setting information conversion unit, a setting/signal conversion table in which a plurality of signal codes respectively corresponding to the plurality of identifiers are stored, and a signal generation unit which obtains a signal code corresponding to an identifier of the code output temporarily set by the internal setting updating unit with reference to the setting/signal conversion table and transmits a temporary setting signal based on the obtained signal code to the device to generate a signal which causes the kind of the temporarily set code output to be displayed on the screen.

In another preferred construction, the internal setting updating unit when input is made to the effect that the main setting is to be conducted, instructs the signal generation unit to generate a final decision signal based on an identifier of a code output temporarily set at present at the specific button, and the signal generation unit refers to the setting/signal conversion table to obtain a signal code corresponding to the identifier of the code output temporarily set at present at the specific button, generate the final decision signal containing the obtained signal code, transmit the generated final decision signal to the device and cause the kind of the code output temporarily set at present to be displayed on the screen.

In another preferred construction, the device includes:
a signal/display contents table in which display screen contents of a kind of code output corresponding to each of the plurality of signal codes are stored, a signal reception processing unit which obtains display screen contents of a relevant code kind from the signal/display contents table based on a temporary setting signal received from the remote control device, and a display screen generation unit which causes the display screen contents obtained by the signal reception processing unit to be displayed on the screen.

In another preferred construction, the internal setting updating unit, when input is made to the effect that the main setting is to be conducted, instructs the signal generation unit to generate a final decision signal based on an identifier of a code output temporarily set at present at the specific button, the signal generation unit refers to the setting/signal conversion table to obtain a signal code corresponding to the identifier of the code output temporarily set at present at the specific button, generate the final decision signal containing the obtained signal code, transmit the generated final decision signal to the device and cause the kind of the code output temporarily set at present to be displayed on the screen, and the signal reception processing unit obtains display screen contents of a relevant code kind from the signal/display contents table based on the final decision signal received from the remote control device and supplies the contents to the display screen generation unit.

According to another aspect of the invention, a remote control device setting method of selecting a desired code output from a plurality of kinds of code outputs and setting the selected code output at a specific button of a remote control device which remotely operates a device capable of screen display by television output, comprising the steps of temporarily setting the specific button by a selected code output, transmitting a signal which causes a kind of the temporarily set code output to be displayed on the screen to the device, and when input is made to the effect that setting is to be conducted, transmitting a signal which causes a kind of a code output temporarily set to the specific button at present to be displayed on the screen to the device.

In the preferred construction, the remote control device setting method further comprising the step of sequentially determining a code output for temporarily setting the specific button from the plurality of kinds of code outputs according to relative input operation.

In another preferred construction, the remote control device setting method further comprising the step of sequentially determining a code output for temporarily setting the specific button from the plurality of kinds of code outputs according to relative input operation, wherein the step of determining a code output according to relative input operation includes the steps of obtaining an identifier of an address corresponding to the relative input operation from an operation/setting conversion table in which a plurality of identifiers which respectively specify kinds of the plurality of kinds of codes are sequentially stored starting at an address as a reference, and temporarily setting the specific button by a code output of a kind corresponding to the obtained identifier.

In another preferred construction, the remote control device setting method further comprising the step of the device, when receiving a signal which causes a kind of the temporarily set code output or a kind of the code output temporarily set at present to be displayed on the screen, of obtaining relevant display screen contents from a signal/display contents table which is provided in the device in question and in which display screen contents related to the plurality of kinds of code outputs are stored and causing the contents to be displayed on the screen.

According to another aspect of the invention, a remote control device which remotely operates a device capable of screen display by television output, comprising:
a specific button which enables setting of a plurality of kinds of code outputs, wherein when input is made to the effect that any one code output of the plurality of kinds of code outputs is to be selected, the specific button is temporarily set by the selected code output, while a signal which causes a kind of a temporarily set code output to be displayed on the screen is transmitted to the device, and when input is made to the effect that main setting is to be conducted, a signal which causes a kind of a code output temporarily set at the specific button at present to be displayed on the screen is transmitted to the device.

In the preferred construction, the remote control device, further comprising an operation button by which relative input operation is conducted, wherein based on an output according to the relative input operation of the operation button, a code output for temporarily setting the specific button is sequentially determined from among the plurality of kinds of codes outputs.

In another preferred construction, the remote control device, further comprising an operation button by which relative input operation is conducted, wherein based on an output according to the relative input operation of the operation button, a code output for temporarily setting the specific button is sequentially determined from among the plurality of kinds of codes outputs, and further comprising:
an operation/setting conversion table where a plurality of identifiers which respectively specify the plurality of kinds of codes are sequentially stored starting at an address as a reference, an output of the operation button being a relative amount of movement from the address as a reference, an operation/setting information conversion unit which obtains an identifier of an address corresponding to an output of the operation button from the operation/setting conversion table, an internal setting updating unit which temporarily sets the specific button by a code output of a kind corresponding to the identifier obtained by the operation/setting information conversion unit, a setting/signal conversion table in which a plurality of signal codes respectively corresponding to the plurality of identifiers are stored, and a signal generation unit which obtains a signal code corresponding to an identifier of the code output temporarily set by the internal setting updating unit with reference to the setting/signal conversion table and transmits a temporary setting signal based on the obtained signal code to the device to generate a signal which causes the kind of the temporarily set code output to be displayed on the screen.

In another preferred construction, the internal setting updating unit, when input is made to the effect that the main setting is to be conducted, instructs the signal generation unit to generate a final decision signal based on an identifier of a code output temporarily set at present at the specific button, and the signal generation unit refers to the setting/signal conversion table to obtain a signal code corresponding to the identifier of the code output temporarily set at present at the specific button, generate the final decision signal containing the obtained signal code, transmit the generated final decision signal to the device and cause the kind of the code output temporarily set at present to be displayed on the screen.

In another preferred construction, the signal reception processing unit obtains display screen contents of a relevant code kind from the signal/display contents table based on the final decision signal received from the remote control device and supplies the contents to the display screen generation unit.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing a schematic structure of a remote control device setting system according to one embodiment of the present invention;

FIG. 2 is a schematic diagram showing one example of a button operation unit of the remote control device shown in FIG. 1;

FIG. 3 is a diagram showing one example of an operation/setting conversion table;

FIG. 4 is a diagram showing one example of a setting/signal conversion table;

FIG. 5 is a diagram showing one example of a signal/display contents conversion table;

FIG. 6 is a flow chart for use in explaining operation of the remote control device shown in FIG. 1;

FIG. 7 is a flow chart for use in explaining operation of a main body of the device shown in FIG. 1;

FIG. 8 is a schematic diagram for use in explaining operation of the main body of the device shown in FIG. 1;

FIG. 9 is a schematic diagram for use in explaining operation of the main body of the device shown in FIG. 1;

FIG. 10 is a schematic diagram for use in explaining operation of the main body of the device shown in FIG. 1; and

FIG. 11 is a schematic diagram for use in explaining operation of the main body of the device shown in FIG. 1.

### DESCRIPTION OF THE PREFERRED EMBODIMENT

The preferred embodiment of the present-invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

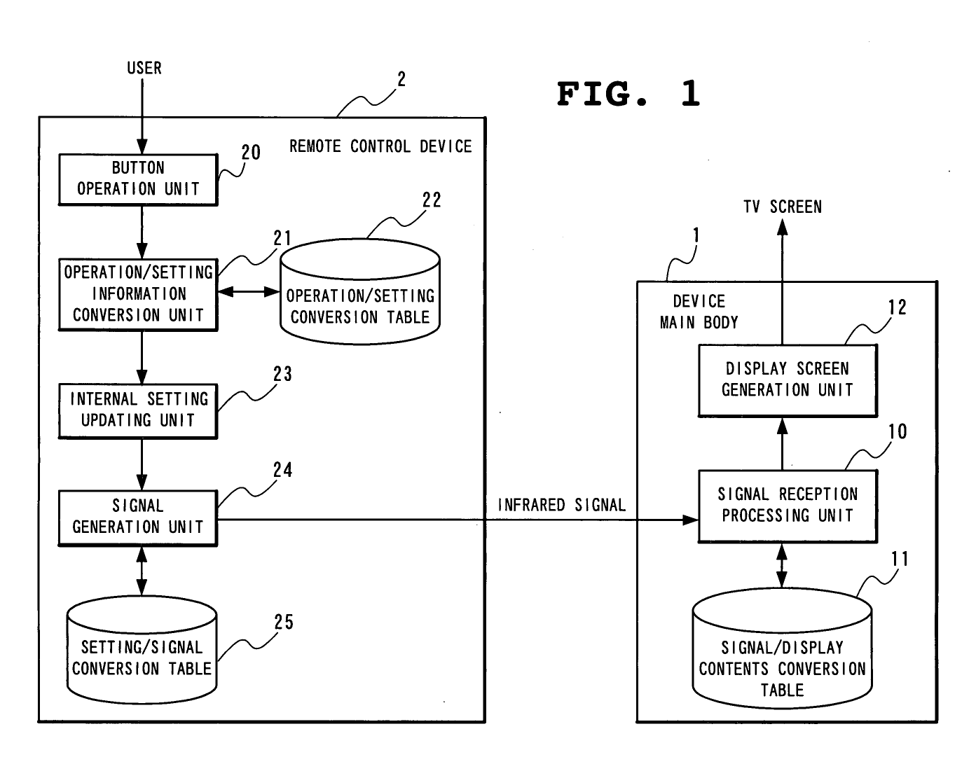

FIG. 1 shows a schematic structure of a remote control device setting system according to one embodiment of the present invention.

The remote control device setting system is composed of a device main body 1 and a remote control device 2 which remotely operates the device main body 1. The device main body 1 is a device having a TV output such as an HDD recorder, a VCR, a DVD player and a BS tuner.

The main part of the device main body 1 is composed of a signal reception processing unit 10, a signal/display contents conversion table 11 and a display screen generation unit 12. The remote control device 2 is attached to the device main body 1, whose main part is composed of a button operation unit 20, an operation/setting information conversion unit 21, an operation/setting conversion table 22, an internal setting updating unit 23, a signal generation unit 24 and a setting/signal conversion table 25.

First, each component of the remote control device 2 will be described specifically. The button operation unit 20 has each operation button arranged which a user operates to set an arbitrary manufacturer code at a specific button (hereinafter, the code setting will be referred to as presetting) and conduct control of a remote control device.

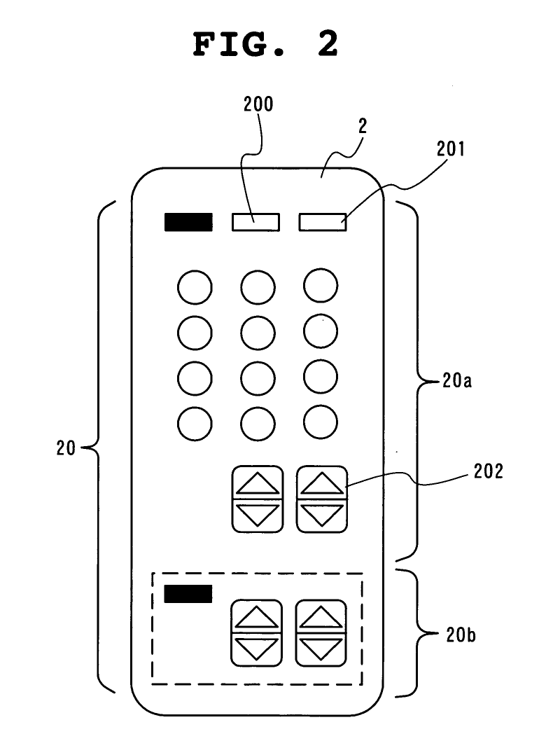

FIG. 2 shows one example of the button operation unit 20. In this example, the button operation unit 20 is composed of a group 20a of device main body buttons for controlling the device main body 1 and a group 20b of television buttons for controlling a television as an external connection apparatus to be connected to the device main body 1.

The group 20a of device main body buttons includes, other than a power button and channel number buttons, a remote control setting button 200, a setting decision button 201 and a “+/−” button 202. The “+/−” button 202 can be used also as, for example, a channel selection button or a volume adjustment button. The remote control setting button 200 is a button for shifting a mode to a preset mode.

In the remote control device 2, when the remote control setting button 200 is pressed, the mode is shifted to the preset mode, while after a setting start signal is transmitted to the device main body 1 to display a screen necessary for presetting (including a list of manufacturer names), presetting operation is conducted by the operation/setting information conversion unit 21, the internal setting updating unit 23 and the signal generation unit 24 which will be described later. The setting decision button 201 is a button for determining on the contents set by the presetting operation to return the mode to an ordinary mode (mode as of before the shift to the preset mode). The group 20b of television buttons includes a power button and a “+/−” button for channel selection and volume adjustment. Here, the group 20b of television buttons is preset to be adapted to the television connected as an external connection apparatus.

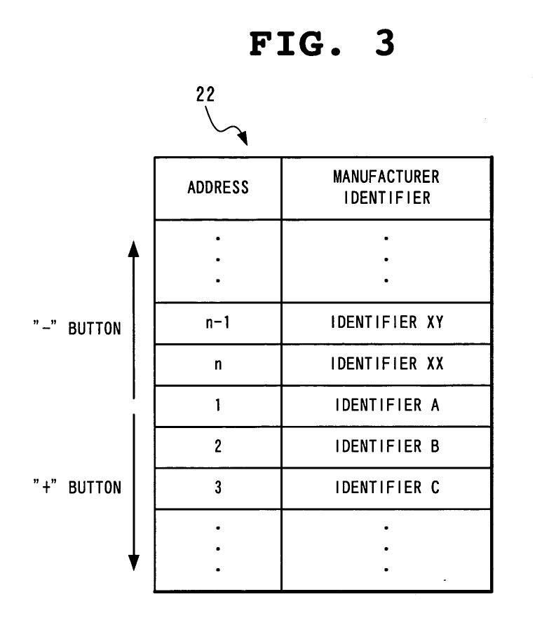

The operation/setting information conversion unit 21 obtains an identifier of a TV manufacturer according to input operation of a “+” button (up button) or a “−” button (down button) in the “+/−” button 202 from the operation/setting conversion table 22. FIG. 3 shows one example of the operation/setting conversion table 22. In this example, the operation/setting conversion table 22 has addresses “1” to “n”, with information indicative of manufacturers “A company”, “B company”and “C company” as identifiers sequentially stored starting at the address “1” and with information indicative of “XX company” stored as an identifier in the last address of “n”.

Manufacturer identifiers stored in the respective addresses of the operation/setting conversion table 22 all correspond to codes of TV manufacturers which can be adapted by presetting. When the “+” button or the “−” button of the “+/−” button 202 is pressed after shifting to the preset mode, the operation/setting information conversion unit 21 reads the identifier stored at the address “1” of the operation/setting conversion table 22 and sends the same to the internal setting updating unit 23. Thereafter, with the address 11 as a reference, every time the “+” button is pressed, an address to be read is carried by one and an identifier stored at the address in question is transmitted to the internal setting updating unit 23. Conversely, when the “−” button is pressed, an address to be read is carried down and an identifier stored at the address in question is transmitted to the internal setting updating unit 23.

The internal setting updating unit 23 temporarily sets the group 20b of television buttons based on a manufacturer identifier supplied from the operation/setting information conversion unit 21, as well as transmitting the manufacturer identifier to the signal generation unit 24 to generate a temporary setting signal which specifies a temporarily set manufacturer. In addition, when the setting decision button 201 is pressed at the button operation unit 20, the internal setting updating unit 23 causes the signal generation unit 24 to generate a final decision signal indicating that a manufacturer temporarily set at present is finally decided on.

When receiving a manufacturer identifier from the internal setting updating unit 23, the signal generation unit 24 refers to the setting/signal conversion table 25 based on the received manufacturer identifier to generate a temporary setting signal which can specify a temporarily set manufacturer and transmit the same to the device main body 1.

FIG. 4 shows one example of the setting/signal conversion table 25. In this example, the setting/signal conversion table 25 stores a temporary setting signal code which can specify a manufacturer with respect to each manufacturer identifier stored in the operation/setting conversion table 22. For example, stored in the column of a manufacturer identifier A is a temporary setting signal code A which can specify A company, stored in the column of a manufacturer identifier B is a temporary setting signal code B which can specify B company and stored in the column of C company is a temporary setting signal code C which can specify C company. For example, when receiving the manufacturer identifier A from the internal setting updating unit 23, the signal generation unit 24 obtains the temporary setting signal code A corresponding to the received manufacturer identifier A from the setting/signal conversion table 25 to generate a temporary setting signal based on the obtained temporary setting signal code A. When receiving a request for the generation of a final decision signal from the internal setting updating unit 23, the signal generation unit 24 further generates a final decision signal to the effect that a manufacturer temporarily set at present will be determined on and transmits the signal to the device main body 1. The final decision signal is one obtained, for example, by adding, to a temporary setting signal of a manufacturer temporarily set at present, an instruction signal to the effect that a manufacturer specified by the temporary setting signal in question will be determined on. Transmission of the signal from the signal generation unit 24 to the device main body 1 is conducted by using infrared communication which is used in remote operation.

Next, each component of the device main body 1 will be specifically described. In the device main body 1, each TV manufacturer name which can be set at the remote control device 2 is registered in advance, and the signal reception processing unit 10 transmits the contents of the list of the registered TV manufacturer names on the screen to the display screen generation unit 12 upon receiving a setting start signal from the remote control device 2. Upon receiving a temporary decision signal transmitted from the signal generation unit 24 at the device main body 1, the signal reception processing unit 10 obtains contents of a display screen from the signal/display contents conversion table 11 based on the received signal and transmits the same to the display screen generation unit 12.

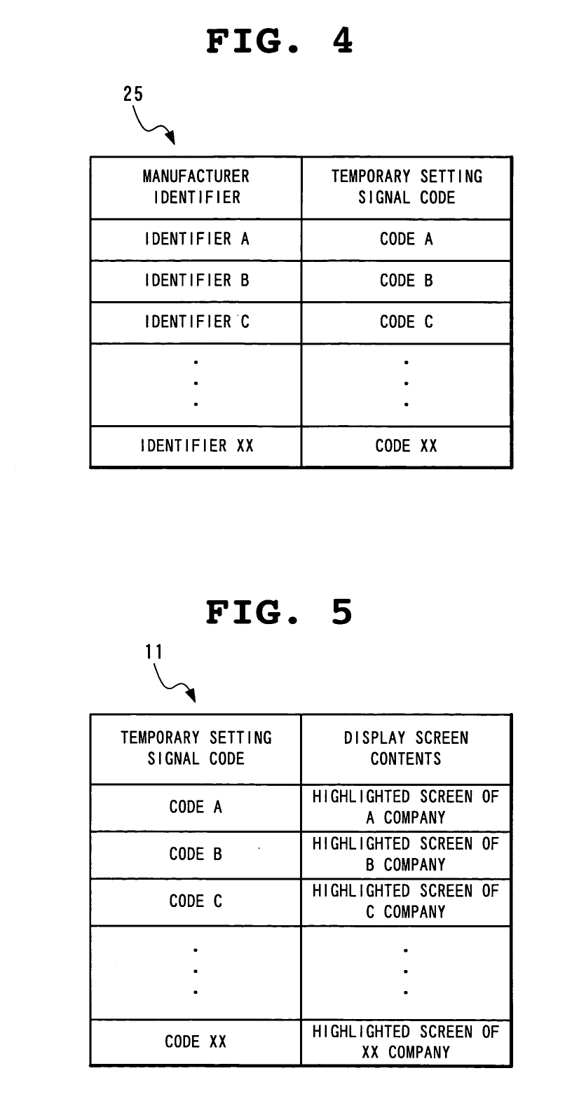

FIG. 5 shows one example of the signal/display contents conversion table 11. In this example, in the signal/display contents conversion table 11, with respect to each temporary setting signal code stored in the setting/signal conversion table 25, contents of a highlighted screen of the corresponding manufacturer name is stored. As to a highlighted screen, with respect to a highlighted screen of A company, for example, the display of “A company” will be highlighted and with respect to a highlighted screen of B company, the display of “B company” will be highlighted. When a final decision signal from the signal generation unit 20 is received at the device main body 1, the signal reception processing unit 10 obtains the display screen contents from the signal/display contents conversion table 11 based on a temporary setting signal contained in the received final decision signal and transmits the contents to the effect that a manufacturer corresponding to the display screen contents in question will be decided on (manufacturer decision screen contents) to the display screen generation unit 12.

TV manufacturer name list screen contents may be obtained from a highlighted screen of each manufacturer name stored in the signal/display contents conversion table 11.

The display screen generation unit 12 generates a display screen (video signal) corresponding to the screen contents supplied from the signal reception processing unit 10 and outputs the generated display screen to the TV connected to the device main body 1 to make the screen be displayed on the TV screen. When, for example, receiving a TV manufacturer name list screen contents from the signal reception processing unit 10, the display screen generation unit 12 generates a display screen of the list of the TV manufacturer names and outputs the same to the TV to make the same be displayed on the TV screen. On the other hand, when receiving the contents of the highlighted screen of A company from the signal reception processing unit 10, the display screen generation unit 12 generates a display screen on which the display of “A company” is highlighted in the list of the TV manufacturer names and outputs the same to the TV to make the screen be displayed on the TV screen.

Display of the above-described TV manufacturer name list screen, a highlighted screen of a manufacturer name and a manufacturer decision screen onto the TV screen is made by GUI (Graphical User Interface), and a user, for example, is allowed to highlight a manufacturer name on a list screen by conducting button operation on the remote control device 2 and select an arbitrary manufacturer name by sequentially shifting the highlighted display to its adjacent manufacturer name.

The list of TV manufacturer names stored in the device main body 1 is made up of manufacturer names one-to-one corresponding to an identifier of each company stored in the operation/setting conversion table 22 of the remote control device 2 and the order of the manufacturer names displayed on the screen coincides with the order of addresses of the operation/setting conversion table 22. Selecting direction of the addresses of the operation/setting conversion table 22 by the “+/−” button coincides with the moving direction (focus moving direction) of the highlight on the screen.

More specifically, when such selection is made of addresses by the “+/−” button as shown in FIG. 2, at a reference position on the screen, “A company” is displayed, from which a plurality of manufacturer names are displayed such as “B company”, “C company” . . . toward the upward direction of the screen and “XX company”, “XY company” . . . toward the downward direction of the screen. In this case, pressing the “+” button results in moving focus toward the upward direction of the screen and pressing the “−” button results in moving focus toward the downward direction of the screen. Although as TV manufacturer name list display, either of the modes can be used, one in which all the manufacturer names are displayed within one screen and the other as scroll display, when the number of manufacturer names is great, it is desirable to employ the scroll display in terms of easiness to see.

Next, operation of the remote control device setting system according to the present embodiment will be described.

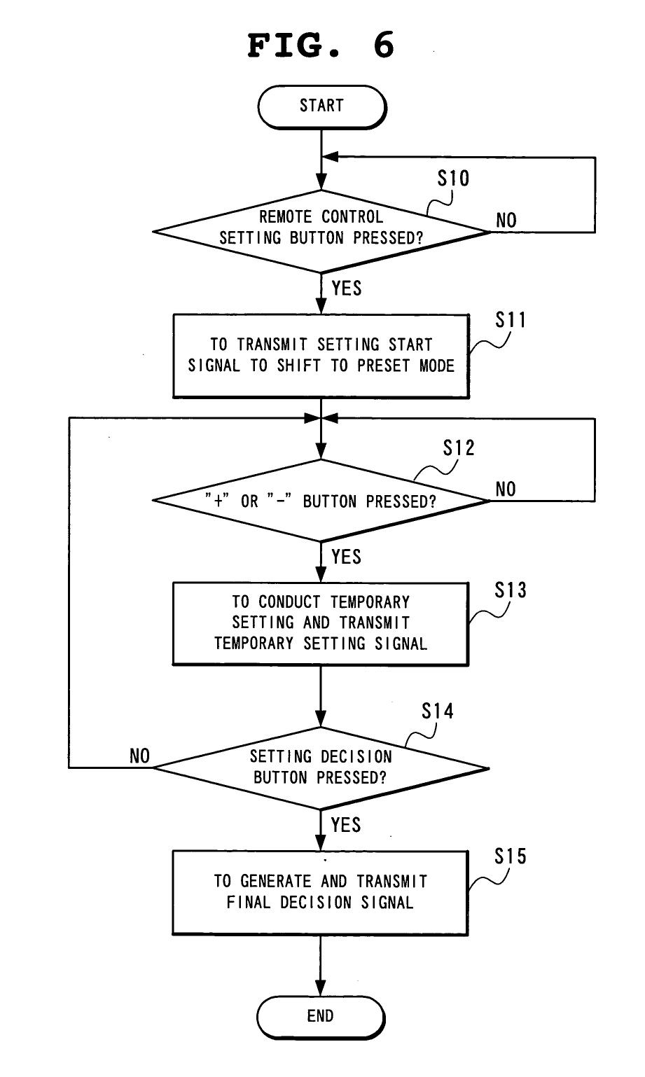

FIG. 6 shows a flow chart for use in explaining operation of the remote control device 2. With reference to FIG. 6, first, determination is made whether the remote control setting button is pressed or not (Step S10). When the determination has “Yes”, transmit a setting start signal to the device main body 1 to shift to the preset mode (Step S11) and when the determination has “No”, repeat Step S10.

When the mode shifts to the preset mode, determination is subsequently made whether “+” or “−” button is pressed (Step S12). When the determination has “No”, repeat Step S13 and when the determination has “Yes”, obtain a manufacturer identifier from the operation/setting conversion table 22 to conduct temporary setting and obtain a temporary setting signal code of the temporarily set manufacturer from the setting/signal conversion table 25 to generate a temporary setting signal based on the obtained code and transmit the same to the device main body 1 (Step S13).

After transmitting the temporary setting signal, determination is subsequently made whether a decision button is pressed or not (Step S14). When the determination has “No”, return to Step S13 and when the determination has “Yes”, generate a final decision signal and transmit the same to the device main body 1 (Step S15).

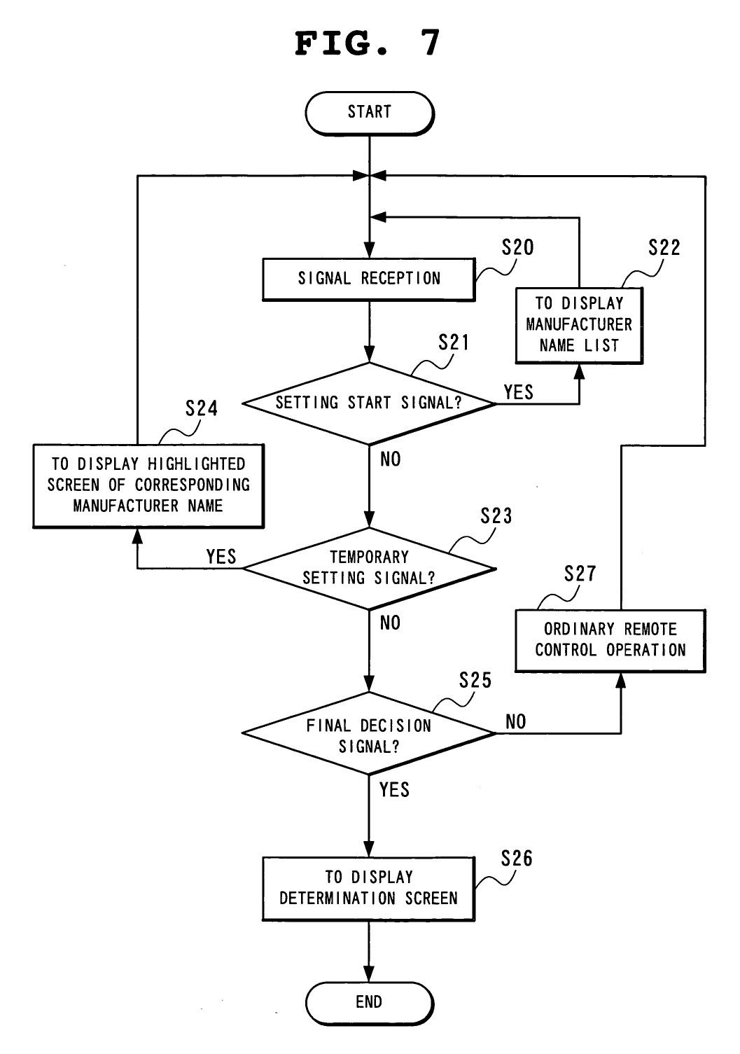

FIG. 7 shows a flow chart for use in explaining operation of the device main body 1. Upon receiving a signal from the remote control device 2 (Step S20), the device main body 1 determines whether the received signal is a setting start signal or not (Step S21). When the determination has “Yes”, make a list screen of TV manufacturers prepared in advance be displayed on the TV screen (Step S22). Thereafter, return to Step S20.

When the determination at the above-described Step S21 has “No”, determination is made whether the received signal is a temporary setting signal (Step S23). When the determination has “Yes”, obtain display screen contents from the signal/display contents conversion table 11 based on the received temporary setting signal to make the same be displayed on the TV screen (Step S24). Thereafter, return to Step S20.

When the determination at the above-described Step S23 has “No”, determination is subsequently made whether the received signal is a final decision signal. (Step S25). When the determination has “Yes”, obtain display screen contents from the signal/display contents conversion table 11 based on a temporary setting signal contained in the received final decision signal to make a manufacturer decision screen (determination screen) to the effect that a manufacturer relevant to the display screen contents will be determined on be displayed on the TV screen (Step S26). When the determination has “No”, conduct ordinary remote control operation according to the received signal (Step S27) and thereafter, return to Step S20.

According to the foregoing processing, after shifting to the preset mode, every time the “+” or “−” button is pressed, highlighted display of a manufacturer name to be preset is sequentially moved on the list screen. In a case, for example, where the “+” button is pressed three times after shifting to the preset mode, first, by the first button operation, a temporary setting signal corresponding to a manufacturer identifier (A company) stored at the address “1” of the operation/setting conversion table 22 is transmitted from the remote control device 2 to the device main body 1, so that the device main body 1 makes a screen in which A company is highlighted be displayed on the TV screen based on the temporary setting signal.

By the subsequent second button operation, a temporary setting signal corresponding to a manufacturer identifier (B company) stored at the address “2” of the operation/setting conversion table 22 is transmitted from the remote control device 2 to the device main body 1, so that the device main body 1 makes a screen in which B company is highlighted be displayed on the TV screen based on the temporary setting signal.

By the subsequent third button operation, a temporary setting signal corresponding to a manufacturer identifier (C company) stored at the address “3” of the operation/setting conversion table 22 is transmitted from the remote control device 2 to the device main body 1, so that the device main body 1 makes a screen in which C company is highlighted be displayed on the TV screen based on the temporary setting signal. Thus, every time the “+” button is pressed, “A company”, “B company” and “C company” are highlighted in this order on the list screen. On the other hand, when the “−” button is pressed, the address of the operation/setting conversion table 22 from which an identifier is obtained will be carried down, so that, for example, when the “−” button is pressed once with “C company” highlighted on the list screen, “B company” will be highlighted in place of “C company”. Accordingly, by operating the “+” and “−” buttons, a user is allowed to arbitrarily conduct temporary setting of preset of the remote control device 2 to confirm the temporarily set manufacturer name on the TV screen.

Moreover, by pressing the setting decision button 202 (see FIG. 1), the user can determine on the preset of the remote control device 2 by the temporarily set manufacturer name. Since at this determination, the determined manufacturer name is displayed on the TV screen, the user can confirm the determined manufacturer from the display. When a different manufacturer is determined on erroneously, press the remote control setting button again to conduct setting again.

In infrared communication, there occurs a case where the device main body 1 can not receive a signal from the remote control device 2 depending on a positional relation between the remote control device 2 and the device main body 1 or a direction of the remote control device 2 to the device main body 1. When there occurs a state where the device main body 1 can not receive a signal from the remote control device 2 during the above-described preset setting, a manufacturer name highlighted on the TV screen will differ from a manufacturer name designated by the user by button operation, that is, from a manufacturer temporarily set at the remote control device 2. In such a case, the user can determine that the signal from the remote control device 2 has not been received by the device main body 1 because in spite of button operation, highlight of the manufacturer name displayed on the TV screen fails to move. Then, by operating the “+” or “−” button until the highlight moves, it is possible to make the manufacturer highlighted on the TV screen and the manufacturer temporarily set at the remote control device 2 coincide with each other.

In the following, an example of operation of avoiding the problem of non-reception during preset setting of the remote control device 2 will be described. Here, the description will be made of a case, as an example, of presetting B company corresponding to the identifier B stored at the address “2” of the operation/setting conversion table 22.

When presetting, the user first presses the remote control setting button 200 on the remote control device 2. When the remote control setting button 200 is pressed, the remote control device 2 shifts to the preset mode, so that a list of TV manufacturer names is displayed on the device main body 1. After shifting to the preset mode, the user presses the “+” or “−” button for temporary setting. When the “+” or “−” button is pressed, the remote control device 2 temporarily sets the TV button 20b in its own remote control device to A company, as well as transmitting a temporary setting signal corresponding to the identifier of A company to the device main body 1. Upon receiving the temporary setting signal (A company) from the remote control device 2, the device main body 1 displays the screen in which “A company” is highlighted on the list screen.

When the screen in which A company is highlighted is displayed on the TV screen, the user subsequently presses the “+” button. When the “+” button is pressed, the remote control device 2 temporarily sets the TV button 20b in its own remote control device to B company, as well as transmitting a temporary setting signal corresponding to the identifier of B company to the device main body 1. Here, assume that the temporary setting signal (B company) transmitted from the remote control device 2 is not received by the device main body 1. Since the device main body 1 fails to receive the temporary setting signal (B company), the display of the screen with “A company” highlighted remains on the TV screen. Therefore, the manufacturer name highlighted on the list screen differs from the manufacturer temporarily set at the remote control device 2.

Because although the “+” button has been pressed, the screen with “A company” highlighted is being displayed, the user notices that the temporary setting signal (B company) has not been received and again presses the “+” button. When the “+” button is pressed, the remote control device 2 temporarily sets the TV button 20b in its own remote control device to C company, as well as transmitting a temporary setting signal corresponding to the identifier of C company to the device main body 1. Upon receiving the temporary setting signal (C company) from the remote control device 2, the device main body 1 highlights “C company” on the list screen. As a result, the highlight moves from “A company” to “C company”jumping over “B company” on the list screen.

After “C company” is highlighted, the user presses the “−” button in order to move the highlight to “B company”. When the “−” button is pressed, the remote control device 2 temporarily sets the TV button 20b in its own remote control device to B company, as well as transmitting a temporary setting signal corresponding to the identifier of B company to the device main body 1. Upon receiving the temporary setting signal (B company) from the remote control device 2, the device main body 1 causes “B company” to be highlighted on the list screen.

Since the highlighted “B company” is a manufacturer name to be used for presetting, the user presses the setting decision button 201 at this stage. When the setting decision button 201 is pressed, the remote control device 2 determines that the TV button 20b in its own remote control device is to be set to B company and transmits a final decision signal containing a temporary setting signal corresponding to the identifier of B company to the device main body 1. Upon receiving the final decision signal from the remote control device 2, the device main body 1 causes a screen indicating, for example, that “B company has been determined on” to be displayed on the TV screen.

Even when the device main body 1 fails to receive the temporary setting signal through the foregoing operation, the user, recognizing the fact, is allowed to reliably preset the remote control device 2 to a target manufacturer.

In the above-described operation conducted when a temporary setting signal is not received, with B company temporarily set on the remote control device 2 side and “A company” being highlighted on the list screen, when the user presses the setting decision button in order to set the remote control device 2 to A company, the device main body 1 displays a screen, for example, indicating that “B company has been determined on” based on the final decision signal (instruction signal+temporary setting signal (B)), so that the user finds from the display that the remote control device 2 has been preset by a manufacturer different from the target manufacturer.

Before determining on a manufacturer by the final decision signal, a screen for checking whether a manufacturer name to be determined on is really satisfactory may be displayed on the TV screen. In this case, by pressing the setting decision button twice, the user will determine on the manufacturer name. In the following, operation conducted in this case will be briefly described.

With the remote control device 2 temporarily set to B company and “B company” being displayed on the TV screen, when the user presses the setting decision button, the remote control device 2 transmits, to the device main body 1, a confirmation signal obtained by adding, to a temporary setting signal (B company) of a manufacturer temporarily set at present, an instruction signal to the effect that whether a manufacturer specified by the temporary setting signal should be determined on or not will be confirmed.

Upon receiving the confirmation signal from the remote control device 2, the device main body 1 obtains display screen contents from the signal/display contents conversion table 11 based on the temporary setting signal (B company) contained in the received confirmation signal to cause the display contents (confirmation screen contents) indicating whether the manufacturer relevant to the display screen contents should be determined on or not to be displayed on the TV screen. According to the display, the user presses the setting decision button when determining on the manufacturer and otherwise presses a cancel button prepared in the button operation unit 20 of the remote control device 2. When the setting decision button is pressed, a screen indicating that “B company has been determined on” is displayed on the TV screen based on a final decision signal on the device main body side 1, while the main setting is conducted on the remote control device 2 side. When the cancel button is pressed, return to a state as of before the first setting decision button is pressed to enable selection of other manufacturer to be subsequently made on the list screen.

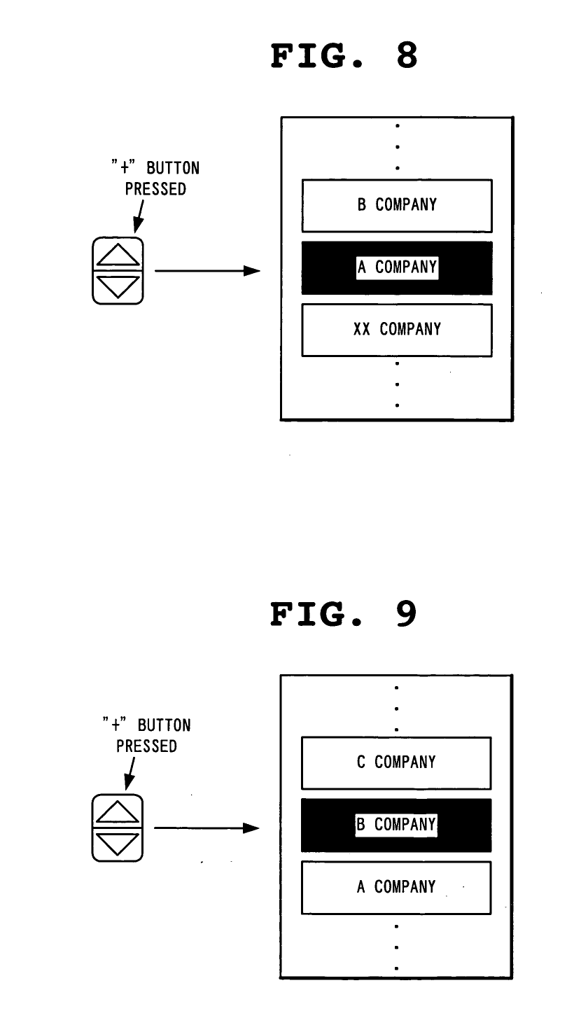

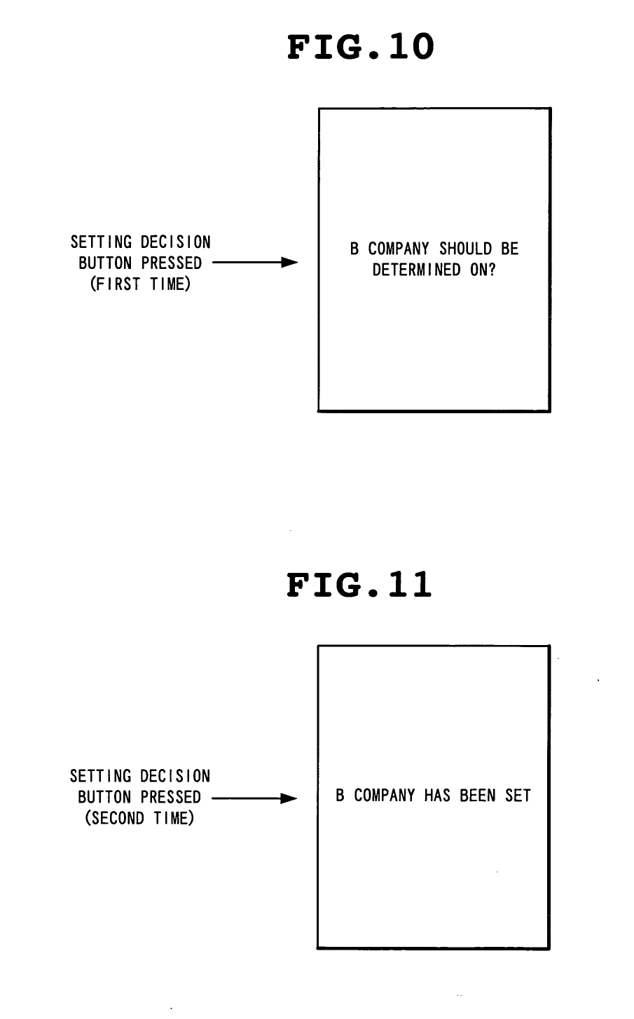

As an example, a flow of operation including the above-described display of a confirmation screen is schematically shown in FIGS. 8, 9, 10 and 11. Pressing the “+” button leads to highlighting “A company” (FIG. 8). Subsequently, pressing the “+” button leads to highlighting “B company” (FIG. 9). Here, when the setting decision button is pressed (first time), a confirmation screen indicating that “determination can be made on B company?” is displayed (FIG. 10) and when the setting decision button is subsequently pressed (second time), a decision screen indicating that “B company has been set” is displayed (FIG. 11).

According to the above-described remote control device setting system of the present embodiment, as shown in FIGS. 8 to 11, for example, a list of manufacturer names which can be set at the remote control device is displayed on the TV screen and a user selects a manufacturer name to be set at the remote control device from the list and decides on the same by operating the “+/−” button on the remote control device. Accordingly, the user can set a desired manufacturer code with ease only with a remote control device even without a manual.

Moreover, because at the time of setting decision, a manufacturer name of a code temporarily set at the remote control device at present is displayed on the TV screen, the user can reliably set a target manufacturer code at the remote control device.

Other than the above-described features, one of important features is realizing selection (moving focus) and decision of a manufacturer code by making the most of utility of GUI display function used so far without a large change of specification.

The remote control device setting system according to the present embodiment described in the foregoing is one example of the present invention and structure and operation of the system can be appropriately changed within the gist of the present invention. The button operation unit, for example, is not limited to that shown in FIG. 2 and various locations and operations of buttons are possible. More specifically, the system may have none of the group 20b of TV buttons and use a specific button of the group 20a of device main body buttons as a button for presetting. In addition, since the remote control setting button 200 is basically a button as a cue to shift a mode and transmit a setting start signal, operation by the remote control setting button 200 may be replaced by button operation, which is not ordinarily conducted, as a combination between a power button and a channel number button. Furthermore, a series of operation by the setting decision button and the “+/−” button may be realized by operation using a decision button and a cross key which are known as a typical button arrangement of a remote control device. In this case, various processing (selection and decision of a manufacturer name and other necessary processing) by GUI display can be executed by a decision button and a cross key. A cancel button may be separately provided.

Since the present invention described above eliminates inconvenience of using a manual, other remote control devices and wires and enables a kind of code output (manufacturer name) to be set at the remote control device while checking the same on the screen, operability and reliability can be improved.

In addition, since a kind of code output can be selected on the screen with ease by relative input operation, operability can be improved to enable provision of a system easy to use and handle.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

1. A remote control device setting system, comprising:
a device capable of screen display by television output, and
a remote control device having a specific button which enables setting of a plurality of kinds of code outputs to remotely operate said device, wherein said remote control device,
when input is made for selecting any one code output of said plurality of kinds of code outputs, temporarily sets said specific button by the selected code output, as well as transmitting, to said device, a signal which causes a kind of a temporarily set code output to be displayed on said screen, and
when input for main setting is made, transmits, to said device, a signal which causes the kind of the code output temporarily set at said specific button to be displayed on said screen.

2. The remote control device setting system as set forth in claim 1,
said remote control device further including an operation button by which relative input operation is conducted, wherein
based on an output according to said relative input operation of the operation button, a code output for temporarily setting said specific button is sequentially determined from among said plurality of kinds of codes outputs.

3. The remote control device setting system as set forth in claim 1,
said remote control device further including
an operation button by which relative input operation is conducted, wherein
based on an output according to said relative input operation of the operation button, a code output for temporarily setting said specific button is sequentially determined from among said plurality of kinds of codes outputs, and further including:
an operation/setting conversion table where a plurality of identifiers which respectively specify said plurality of kinds of codes are sequentially stored starting at an address as a reference,
an output of said operation button being a relative amount of movement from said address as a reference,
an operation/setting information conversion unit which obtains an identifier of an address corresponding to an output of said operation button from said operation/setting conversion table,
an internal setting updating unit which temporarily sets said specific button by a code output of a kind corresponding to the identifier obtained by said operation/setting information conversion unit,
a setting/signal conversion table in which a plurality of signal codes respectively corresponding to said plurality of identifiers are stored, and
a signal generation unit which obtains a signal code corresponding to an identifier of the code output temporarily set by said internal setting updating unit with reference to said setting/signal conversion table and transmits a temporary setting signal based on the obtained signal code to said device to generate a signal which causes the kind of said temporarily set code output to be displayed on said screen.

4. The remote control device setting system as set forth in claim 3, wherein
said internal setting updating unit when input is made to the effect that said main setting is to be conducted, instructs said signal generation unit to generate a final decision signal based on an identifier of a code output temporarily set at present at said specific button, and
said signal generation unit refers to said setting/signal conversion table to obtain a signal code corresponding to the identifier of the code output temporarily set at present at said specific button, generate said final decision signal containing the obtained signal code, transmit the generated final decision signal to said device and cause the kind of said code output temporarily set at present to be displayed on said screen.

5. The remote control device setting system as set forth in claim 3, wherein said device includes:
a signal/display contents table in which display screen contents of a kind of code output corresponding to each of said plurality of signal codes are stored,
a signal reception processing unit which obtains display screen contents of a relevant code kind from said signal/display contents table based on a temporary setting signal received from said remote control device, and
a display screen generation unit which causes the display screen contents obtained by said signal reception processing unit to be displayed on said screen.

6. The remote control device setting system as set forth in claim 3, wherein
said internal setting updating unit, when input is made to the effect that said main setting is to be conducted, instructs said signal generation unit to generate a final decision signal based on an identifier of a code output temporarily set at present at said specific button,
said signal generation unit refers to said setting/signal conversion table to obtain a signal code corresponding to the identifier of the code output temporarily set at present at said specific button, generate said final decision signal containing the obtained signal code, transmit the generated final decision signal to said device and cause the kind of said code output temporarily set at present to be displayed on said screen, and
said signal reception processing unit obtains display screen contents of a relevant code kind from said signal/display contents table based on said final decision signal received from said remote control device and supplies the contents to said display screen generation unit.

7. A remote control device setting method of selecting a desired code output from a plurality of kinds of code outputs and setting the selected code output at a specific button of a remote control device which remotely operates a device capable of screen display by television output, comprising the steps of:
temporarily setting said specific button by a selected code output,
transmitting a signal which causes a kind of said temporarily set code output to be displayed on said screen to said device, and
when input is made to the effect that setting is to be conducted, transmitting a signal which causes a kind of a code output temporarily set to said specific button at present to be displayed on said screen to said device.

8. The remote control device setting method as set forth in claim 7, further comprising
the step of sequentially determining a code output for temporarily setting said specific button from said plurality of kinds of code outputs according to relative input operation.

9. The remote control device setting method as set forth in claim 7, further comprising
the step of sequentially determining a code output for temporarily setting said specific button from said plurality of kinds of code outputs according to relative input operation, wherein
said step of determining a code output according to relative input operation includes the steps of:
obtaining an identifier of an address corresponding to said relative input operation from an operation/setting conversion table in which a plurality of identifiers which respectively specify kinds of said plurality of kinds of codes are sequentially stored starting at an address as a reference, and
temporarily setting said specific button by a code output of a kind corresponding to said obtained identifier.

10. The remote control device setting method as set forth in claim 7, further comprising the step of
said device, when receiving a signal which causes a kind of said temporarily set code output or a kind of said code output temporarily set at present to be displayed on said screen, of obtaining relevant display screen contents from a signal/display contents table which is provided in the device in question and in which display screen contents related to said plurality of kinds of code outputs are stored and causing the contents to be displayed on said screen.

11. A remote control device which remotely operates a device capable of screen display by television output, comprising:
a specific button which enables setting of a plurality of kinds of code outputs, wherein
when input is made to the effect that any one code output of said plurality of kinds of code outputs is to be selected, said specific button is temporarily set by the selected code output, while a signal which causes a kind of a temporarily set code output to be displayed on said screen is transmitted to said device, and when input is made to the effect that main setting is to be conducted, a signal which causes a kind of a code output temporarily set at said specific button at present to be displayed on said screen is transmitted to said device.

12. The remote control device as set forth in claim 11, further comprising an operation button by which relative input operation is conducted, wherein based on an output according to said relative input operation of the operation button, a code output for temporarily setting said specific button is sequentially determined from among said plurality of kinds of codes outputs.

13. The remote control device as set forth in claim 11, further comprising
an operation button by which relative input operation is conducted, wherein based on an output according to said relative input operation of the operation button, a code output for temporarily setting said specific button is sequentially determined from among said plurality of kinds of codes outputs, and further comprising:
an operation/setting conversion table where a plurality of identifiers which respectively specify said plurality of kinds of codes are sequentially stored starting at an address as a reference,
an output of said operation button being a relative amount of movement from said address as a reference,
an operation/setting information conversion unit which obtains an identifier of an address corresponding to an output of said operation button from said operation/setting conversion table,
an internal setting updating unit which temporarily sets said specific button by a code output of a kind corresponding to the identifier obtained by said operation/setting information conversion unit,
a setting/signal conversion table in which a plurality of signal codes respectively corresponding to said plurality of identifiers are stored, and
a signal generation unit which obtains a signal code corresponding to an identifier of the code output temporarily set by said internal setting updating unit with reference to said setting/signal conversion table and transmits a temporary setting signal based on the obtained signal code to said device to generate a signal which causes the kind of said temporarily set code output to be displayed on said screen.

14. The remote control device as set forth in claim 13, wherein
said internal setting updating unit, when input is made to the effect that said main setting is to be conducted, instructs said signal generation unit to generate a final decision signal based on an identifier of a code output temporarily set at present at said specific button, and
said signal generation unit refers to said setting/signal conversion table to obtain a signal code corresponding to the identifier of the code output temporarily set at present at said specific button, generate said final decision signal containing the obtained signal code, transmit the generated final decision signal to said device and cause the kind of said code output temporarily set at present to be displayed on said screen.

15. The remote control device as set forth in claim 13, wherein
said signal reception processing unit obtains display screen contents of a relevant code kind from said signal/display contents table based on said final decision signal received from said remote control device and supplies the contents to said display screen generation unit.
